(19) United States
(12) Patent Application Publication
(10) Pub. No.: US 2009/0278465 A1
(43) Pub. Date: Nov. 12, 2009

(54) POWER CONVERSION UNIT FOR LED LIGHTING

(75) Inventors: Ronald Farmer, Houston, TX (US); Arash Tom Salamat, Plano, TX (US); Guenter Lehmann, Plano, TX (US)

Correspondence Address: AKIN GUMP STRAUSS HAUER & FELD LLP, 1111 Louisiana Street, 44th Floor, Houston, TX, 77002, US

(73) Assignee: U.S. LED, LTD., Houston, TX (US)

(21) Appl. No.: 12/118,061

(22) Filed: May 9, 2008

(51) Int. Cl. H05B 37/02; H02M 7/02

(52) U.S. Cl. 315/209 R; 363/126

(57) ABSTRACT

A power conversion unit converts an AC voltage into substantially constant DC current. The power conversion unit can be placed into an end cap of an LED lighting unit, to power LED modules. The power conversion unit uses capacitors and a bridge rectifier to perform the power conversion. The capacitors and bridge rectifier are selected to configure the power conversion and to produce the desired variable voltage substantially constant DC current.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to the field of lighting systems, and in particular to lighting systems utilizing light emitting diodes (LEDs).

2. Description of the Related Art

Since Thomas Edison's invention of the incandescent light bulb, numerous types of light bulbs and lighting systems have been developed. Incandescent lights were followed by flourescent lights, and today LED lights have been used as an alternative to earlier forms of lighting systems, because of their durability, long life, and energy efficiency compared to incandescent and fluorescent lights.

### BRIEF SUMMARY OF THE INVENTION

Embodiments consistent with the present invention provide a way to use LED lighting units in retrofit and new environments. A power conversion unit provides a simple, efficient, and small circuit for converting AC power to DC current for driving LED lighting units. A lighting system utilizing LEDs provides a housing, an LED module, and a power conversion circuit.

In one embodiment, a power conversion circuit comprises an AC power input line; a bridge rectifier; a first capacitor, connected between a first leg of the AC power input line and a first input of the bridge rectifier; a first DC output line, connected to a first output of the bridge rectifier; a second DC output line, connected to a second output of the bridge rectifier; wherein the first capacitor and the bridge rectifier are selected to provide a predetermined variable voltage substantially constant DC current on the first and second DC output lines.

In a second embodiment, a lighting module comprises a housing comprising: a channel having a longitudinal opening; and a lens adapted to cover the opening; a light emitting diode (LED) module adapted for positioning within the channel, comprising: a plurality of LEDs mounted on one or more circuit boards; and a power conversion circuit board, adapted for positioning in the housing, the power conversion circuit board comprising: an AC power input line, adapted for connection to an AC power source; a bridge rectifier; a first capacitor, connected between a first leg of the AC power input line and a first input of the bridge rectifier; a first DC output line, connected to a first output of the bridge rectifier and adapted for connection to the LED module, wherein the first capacitor and the bridge rectifier are selected to provide a predetermined variable voltage substantially constant DC current on the first and second DC output lines.

Other lighting system, methods, features, and advantages consistent with the present invention will become apparent to one with skill in the art upon examination of the following figures and detailed description. It is intended that such additional systems, methods, features, and advantages by included within this description and be within the scope of the invention.

### BRIEF DESCRIPTION OF THE SEVERAL VIEWS OF THE DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is an exemplary end view of an LED lighting unit according to one embodiment;

FIG. 2 is an exemplary schematic illustrating a power conversion circuit for use with LED lighting systems;

FIG. 3 is an end view of an end cap for use with the embodiment of FIG. 1; and

FIG. 4 is a cutaway end view of the end cap of FIG. 3.

### DETAILED DESCRIPTION OF THE INVENTION

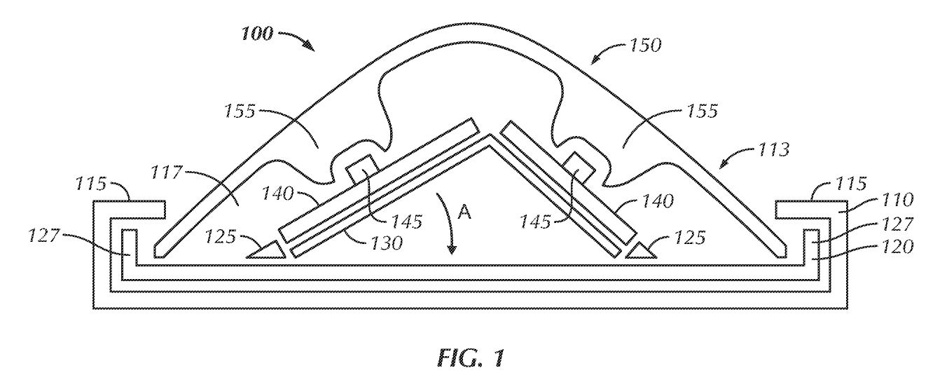

FIG. 1 is an end view of an LED lighting unit 100 according to one embodiment. A generally C-shaped housing 110, which can be made of plastic, metal, or any other desirable substance, serves as a housing for the lighting unit 100, and forms a channel 117 into which other parts of the lighting unit 100 can be inserted and an opening 113 through which the other parts can be inserted.

A generally U-shaped holder 120 is positioned inside the channel 117, and is held in place by lips 115 formed in the C-shaped housing base 110. A pair of ridges 125 are formed longitudinally in holder 120. These ridges are shown in FIG. 1 as generally triangular protrusions in the upper surface of the U-shaped holder 120, but other ridge configurations can be used. Alternately, instead of ridges 125, indentations or grooves could be formed in the holder 120. The ridges 125 do not need to extend for the entire length of the housing base 110, and may be composed of multiple separated sections. The ridges (or grooves) 125 hold a mount 130 in place in the lighting unit 100, and keep the mount 130 from moving from side to side in the channel 117 when fully assembled.

The mount 130 is an angled piece formed to engage the ridges 125. The angle of mount 130 is configured to position the LED modules 140 at a desired acute angle A to the opening 113 when placed on the mount 130. Such an angled positioning can be used to achieve a desired illumination coverage from the LED modules 140.

In other embodiments mount 130 can be eliminated and the LED modules 140 positioned directly on the U-shaped holder 120 or directly on the C-shaped housing base 110 without an angled positioning of the LED modules 140.

The LED module 140 is a circuit board on which is mounted one or more LEDs 145. Depending on the length of the LED lighting unit 100 or the LED module 140, multiple LED modules 140 may be mounted along the LED lighting unit 100. Although as shown in FIG. 1 only a single LED 145 is visible on each LED module 140, the LED module 140 can contain any number of LEDs 145 as desired. An example LED module that can be used is the LED module disclosed in U.S. patent application Ser. No. 11/091,191, assigned to the assignee of the current application. Although as shown in FIG. 1, two LED modules 140 are mounted on mount 130, in some embodiments only one side of the mount 130 can be used for mounting LED modules 140.

Any desired color or mixture of colors of LEDs 145 can be used in the LED modules 140. The LED module 140 illustrated in FIG. 1 is also held in place by ridges 125, allowing easy positioning and replacing or repositioning of the LED modules 140. The LED modules 140 contain circuitry to cause illumination of the LEDs 145 when provided with a DC current at a current level defined by the manufacturer of the LEDs 145 and the desired lighting level from the LED 145.

A lens 150 is placed over the LED modules 140. As shown in FIG. 1, an angled lens is positioned such that a side portion of the lens 150 is held in place under lip 115, resting on U-shaped holder 120, and abutting lip 127 of the U-shaped holder 120. The lens 150 can be deformed slightly for insertion into the lighting unit 100. Then when released, the lens 150 is held in place, preventing accidental disassembly of the lighting unit 100.

In one embodiment, illustrated in FIG. 1, an LED retainer section 155 protrudes from the body of the lens 150 against the LEDs 145 when the lens 150 is inserted into the lighting unit 100, for retaining the LED module 140 in place with the mount 130. The lens 150 when in mounted position should cover the opening 113 and the outer surface of the lens 150 as illustrated in FIG. 1 is generally parallel to the LED modules 140 at the point closest to the LEDs 145. The lens 140 can be made of any desired optically transparent or translucent material, such as an optical grade acrylic. In some embodiments, the lens 150 or parts thereof, such as the LED retainer section 155, are refractive.

Although as illustrated in FIG. 1, the lens 150 is angled, the lens 140 can be a flat, curved, or otherwise shaped lens. Other techniques and configurations for retaining the lens 150 in the housing unit 150 can be used.

The lighting unit 100 can be used in a wide variety of applications, including retrofit applications where a non-LED lighting unit is replaced with the LED lighting unit 100. In some applications, the LED unit 100 may need to convert an AC power source to DC power, preferably a substantially constant current DC power source. In other applications, power conversion may not be required, and an appropriate DC power source is available for use in powering the lighting unit 100. When only an AC power source is available, a power conversion unit according to one or more embodiments can be used.

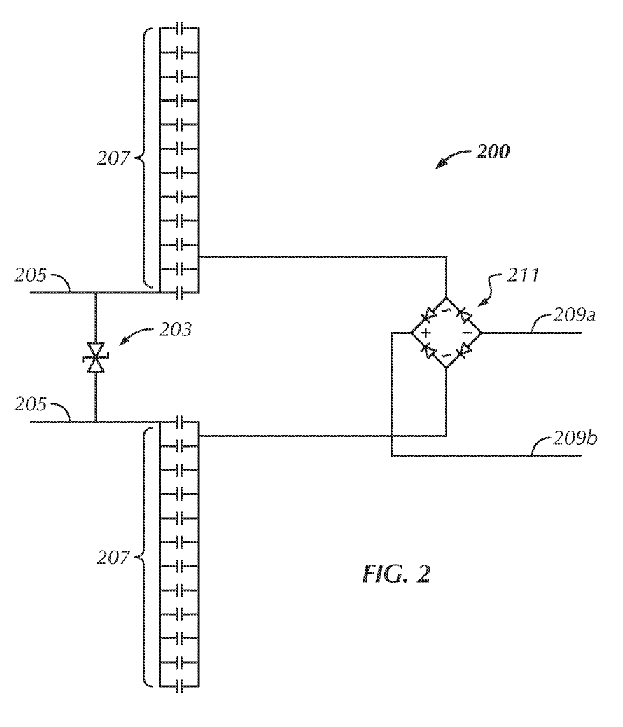

FIG. 2 is a schematic illustrating a power conversion unit 200 for use with the LED lighting unit 100 of FIG. 1. The power conversion unit 200 converts an AC input voltage into a DC output current. The AC input voltage is typically from a 120 VAC power source and is converted into a variable voltage substantially constant DC current of the desired amperage, but any AC power source voltage can be used by appropriate configuration of the power conversion unit 200. As shown in FIG. 2, two legs of an AC power input line 205 connect to one or more capacitors 207. A TVS varistor 203 or other isolating circuit element is connected between legs 205 for electrical isolation of those legs from each other. The power conversion unit 200 supplies a substantially constant DC current of variable DC voltage on DC output lines 209A and 209B.

Capacitors 207 are connected in parallel between AC power input line legs 205 and an input of a bridge rectifier 211 as shown in FIG. 1. The DC output lines 209A and 209B are connected to the two outputs of the bridge rectifier 211.

The number and capacitance of the capacitors 207 is selected to ensure that a predetermined variable voltage constant DC current is provided on DC output lines 209A and 209B. If there are more LEDs 145 and LED modules 140, then one or more of the capacitance and number of capacitors 207 can be increased. The capacitors 207 do not need to be of equal capacitance. For example, in one embodiment, in which LED lighting unit 100 is one foot long with 16 LEDs at 3.5 VDC per LED, six capacitors 207 can be used, with two of 2.2 μF and four of 1 μF. In a second embodiment, using a two foot long LED lighting unit 100, with twice the number of LED modules 140, eight capacitors 207 can be used, with six of 2.2 μF and two of 1.5 μF. The current rating of the LEDs 145 of the LED module 140 will also affect one or more of the capacitance and number of capacitors 207 used for the power conversion unit 200. Although as shown in FIG. 1, multiple capacitors are used on each leg of the AC power source, a single capacitor 207 of an appropriate capacitance can be used for each leg of the circuit.

The bridge rectifier 211 is also selected to ensure the predetermined variable voltage substantially constant DC current is achieved. In one embodiment, it is a 200 volt, 1 amp bridge rectifier.

Test points can be created at desired locations on the power conversion unit. In one embodiment, the DC output lines 209A and 209B do not directly connect to the LED modules 140, but connect to a connector board (not shown) which then connects to the LED modules 140.

In one embodiment, only one leg 205 of the AC power circuit is connected through capacitors 207 to the bridge rectifier 211, with the other leg 205 connected directly to the other input of the bridge rectifier 211. In some embodiments, the DC output lines have a maximum DC voltage of less than 60 VDC, to ensure a safe working voltage.

The capacitors 207 are typically surface mounted ceramic capacitors, but other types of capacitors can be used, as long as the capacitors 207 are non-polarized capacitors.

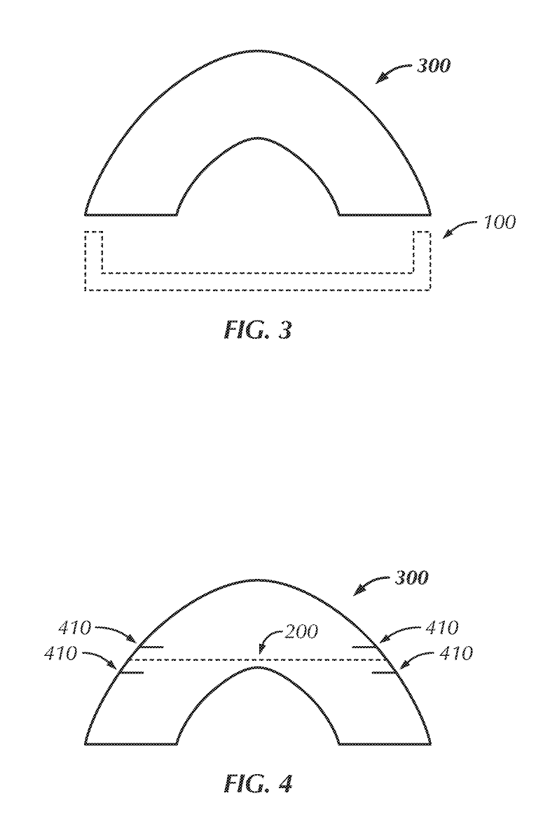

The power conversion unit 200 can be made small enough to fit into an endcap for the lighting unit 100. An end cap 300 according to one embodiment is shown in end view in FIG. 3. The endcap 300 plugs the opening 113 of the lighting unit 100, as well as holding the power conversion unit illustrated in FIG. 2. If desired, grooves can be formed on the exterior of lighting unit 100 to help hold and stabilize the endcap 300 when mounted on the lighting unit 100. As shown in FIG. 4 which is a cutaway end view of the endcap 300, tabs 410 can be formed interior to endcap 300 to hold the power conversion unit 200 in the end cap 300. A hole can be formed in an end surface of endcap 300 for connecting a conduit or cable the AC power input lines 205 of the power conversion unit 200. If necessary vent holes can also be formed in the endcap 300 to vent heat from the lighting unit 100, but the lighting unit 100 and power conversion unit 200 typically produce low amounts of heat, allowing the lighting unit 100 to be used in applications such as freezer units, where high heat generation would be unacceptable. In addition to freezer units, the lighting unit 100 can be used in a wide variety of other applications, including under counter lighting and display case lighting applications. Embodiments suitable to those applications may vary in details from the illustrative embodiments exemplified in the drawings.

While certain exemplary embodiments have been described in details and shown in the accompanying drawings, it is to be understood that such embodiments are merely illustrative of and not devised without departing from the basic scope thereof, which is determined by the claims that follow. By way of example and not limitation, the specific electrical components utilized may be replaced by known equivalents or other arrangements of components which function similarly and provide substantially the same result.

We claim:

1. A power conversion circuit, comprising:
an AC power input line;
a bridge rectifier;
a first capacitor, connected between a first leg of the AC power input line and a first input of the bridge rectifier;
a first DC output line, connected to a first output of the bridge rectifier; and
a second DC output line, connected to a second output of the bridge rectifier,
wherein the first capacitor and the bridge rectifier are selected to provide a predetermined variable voltage substantially constant DC current on the first and second DC output lines.

2. The power conversion circuit of claim 1, wherein the first leg and the second leg of the AC power input line are electrically isolated from each other.

3. The power conversion circuit of claim 1, further comprising:
a second capacitor connected between a second leg of the AC power input line and a second input of the bridge rectifier,
wherein the first capacitor, the second capacitor, and the bridge rectifier are selected to provide the predetermined variable voltage substantially constant DC current on the first and second DC output lines.

4. The power conversion circuit of claim 3, wherein the first capacitor and the second capacitor are of equal capacitance.

5. The power conversion circuit of claim 1, further comprising:
a third capacitor, connected in parallel with the first capacitor between the first leg of the AC power input line and the first input of the bridge rectifier;
wherein the first capacitor, the third capacitor, and the bridge rectifier are selected to provide the predetermined variable voltage substantially constant DC current on the first and second DC output lines.

6. The power conversion circuit of claim 1, further comprising:
a plurality of capacitors, each connected in parallel with each other and the first capacitor between the first leg of the AC power input line and the first input of the bridge rectifier,
wherein the first capacitor, the plurality of capacitors, and the bridge rectifier are selected to provide the predetermined variable voltage substantially constant DC current on the first and second DC output lines.

7. The power conversion circuit of claim 1, wherein the predetermined variable voltage constant DC current is sufficient to drive a predetermined number of predetermined light emitting diodes (LEDs).

8. The power conversion circuit of claim 1, wherein the first capacitor is a ceramic capacitor.

9. The power conversion circuit of claim 1, wherein the first capacitor is a non-polarized capacitor.

10. The power conversion circuit of claim 1, wherein the maximum DC voltage on the first and second DC output lines is less than 60 vDC.

11. A lighting module, comprising:
a housing comprising:
a channel having a longitudinal opening; and
a lens adapted to cover the opening;
a light emitting diode (LED) module adapted for positioning within the channel, comprising:
a plurality of LEDs mounted on one or more circuit boards; and
a power conversion circuit board, adapted for positioning in the housing, the power conversion circuit board comprising:
an AC power input line, adapted for connection to an AC power source;
a bridge rectifier;
a first capacitor, connected between a first leg of the AC power input line and a first input of the bridge rectifier; and
a first DC output line, connected to a first output of the bridge rectifier and adapted for connection to the LED module,
wherein the first capacitor and the bridge rectifier are selected to provide a predetermined variable voltage substantially constant DC current on the first and second DC output lines.

12. The lighting module of claim 11, wherein the first capacitor is selected responsive to the cardinality of the plurality of LEDs.

13. The lighting module of claim 11, the power conversion circuit board further comprising:
a plurality of capacitors connected in parallel to each other and to the first capacitor, each having a predetermined capacitance, selected responsive to the cardinality of the plurality of LEDs.

14. The lighting module of claim 11, the power conversion circuit board further comprising:
a plurality of capacitors connected in parallel to each other and to the first capacitor, each having a predetermined capacitance, the cardinality of the plurality of capacitors selected responsive to the cardinality of the plurality of LEDs.

15. The lighting module of claim 11, the power conversion circuit board further comprising:
a plurality of capacitors connected in parallel to each other and to the first capacitor, each having a predetermined capacitance, the cardinality of the plurality of capacitors and the capacitance of each capacitor selected responsive to the length of the LED module.

16. The lighting module of claim 11, further comprising:
an end cap configured for attachment to and closure of the channel,
wherein the power conversion circuit board is configured for positioning in the end cap.

17. The lighting module of claim 16, wherein the endcap stabilizes the top of the lens when the end cap is attached to the channel.

18. The lighting module of claim 11, wherein the lens is refractive.

19. The lighting module of claim 11, where the LED module is positioned at an acute angle relative to the opening.

20. The lighting module of claim 19, the channel comprising:
a generally C-shaped base forming the longitudinal opening;
a generally U-shaped holder, positioned with the base; and
a generally inverted-V-shaped holder, positioned on the U-shaped holder,
and adapted to position the LED module at the acute angle relative to the opening.

21. The lighting module of claim 20, the lens configured for insertion into the opening formed by the generally C-shaped base, and further configured to retain the LED module with the generally inverted V-shaped module

22. The lighting module of claim 19, the generally C-shaped base comprising:
a pair of longitudinal grooves, one formed on each side of the generally C-shaped base; and
an end cap configured to engage with the pair of longitudinal grooves.

23. A method comprising:
electrically connecting a first leg of an AC power line to a first capacitive circuit;
electrically connecting the capacitive circuit to a first input of a bridge rectifier;
providing a predetermined variable voltage substantially constant DC current on a first output of the bridge rectifier; and
selecting the capacitance of the first capacitive circuit and selecting the bridge rectifier based on the predetermined variable voltage substantially constant DC current to be provided.

24. The method of claim 23, electrically connecting a first leg of an AC power line to a first capacitive circuit comprising:
electrically connecting a plurality of capacitors in parallel; and
electrically connecting the leg of the AC power line to the plurality of capacitors.

25. The method of claim 23, further comprising:
electrically connecting a second leg of an AC power line to a second capacitive circuit;
electrically connecting the second capacitive circuit to a first input of a bridge rectifier; and
providing the predetermined variable voltage substantially constant DC current on a second output of the bridge rectifier.
